(19) United States
(12) Patent Application Publication
(10) Pub. No.: US 2006/0219058 A1
(43) Pub. Date: Oct. 5, 2006

(54) Bottle Opener

(75) Inventors: Christopher A. Farentinos, Redondo Beach, CA (US); Steven N. Farentinos, Torrance, CA (US)

Correspondence Address: STEVEN N. FARENTINOS, 5030 DEELANE ST., TORRANCE, CA, 90503, US

(73) Assignees: Mr. Christopher A. Farentinos, Redondo Beach, CA (US); Mr. Steven N. Farentinos, Torrance, CA (US)

(21) Appl. No.: 10/907,512

(22) Filed: Apr. 4, 2005

(51) Int. Cl. B67B 7/16

(52) U.S. Cl. 81/3.55

(57) ABSTRACT

A bottle opener is provided for uncapping a bottle of beer, soft drink or other liquid container that has been sealed with a crown cap. The opener is operable using only one hand. The opener can be manipulated using the thumb and one other finger and can be placed into its operative position upon the bottle cap while holding the bottle in the same hand. This has the advantage of allowing, for example, a waiter or an individual with the use of only one hand, to secure the bottle from slipping or tipping over and to lift the bottle from a table before attempting to place the opener in its operative position upon the cap.

### FIELD OF THE INVENTION

The present invention relates to an opener for uncapping a bottle of beer, soft drink or other liquid container that has been sealed with a crown cap.

### DESCRIPTION OF RELATED ART

A wide variety of bottle openers is known in the art. Low, in U.S. Pat. Nos. 1,214,802 and 2,155,947 describes variations of a bottle opener which can be operated using one hand. However, Low's one-handed design requires that the opener be placed in position upon the bottle cap before the fingers of the same hand are able to reach and grasp the bottle neck. This drawback results in the propensity to tip or tumble the bottle while engaging the opener. It also requires that the unopened bottle is supported by a table or other structure while the opener is being engaged with the bottle cap. Kichijyo, in U.S. Pat. No. 4,414,866 describes a one-handed bottle opener composed of various levers and springs. This device is operated by pushing down on the opener, or by gripping a lever. Other one-handed bottle openers are similarly complicated, involving linkages and other moving parts, resulting in high cost of manufacturing and propensity for breaking. These include Ranseen U.S. Pat. No. 2,440,485, Chapman U.S. Pat. No. 2,961,902, Sprich U.S. Pat. No. 2,593,358, Talbot U.S. Pat. No. 2,551,511, Davis U.S. Pat. No. 4,702,130, Salcedo U.S. Pat. No. 4,852,432.

These one-handed openers all require a surface, such as a table, supporting the bottle as the opener is being placed into its operative position upon the bottle cap. Related art also includes various glove and strap-on type bottle openers such as, Erwin U.S. Pat. No. 5,133,233, Kondos U.S. Pat. No. 5,261,299, Sasso U.S. Pat. No. 6,761,088.

### BRIEF SUMMARY OF THE INVENTION

It is an objective of this invention to provide a new bottle opener which incorporates many of the advantages of related art, while simultaneously overcoming the disadvantages and offering new advantages.

The opener is preferably made from one piece of metal, or other suitable material such as plastic. The opener can also be made from a combination of suitable materials. It has no moving parts and no adjustments, such as straps. This simplicity allows for very low cost of manufacturing, similar to traditional two-handed bottle openers (one hand holding the opener and the other holding the bottle) made from one piece of material. However, the present invention departs significantly from related art by allowing the user to grasp the bottle first, and then engage the opener. In related art, one-handed openers require a structure underneath the bottle, such as a table, to support the bottle while the opener is engaged. In the present invention the opener can be manipulated using only the thumb and one finger. Engagement of the opener with the bottle cap can be accomplished while holding the bottle between the remaining unused fingers and palm of the hand without a supporting surface, such as a table, beneath the bottle. This significant departure from related art provides novel convenience for individuals, such as a bartender carrying the bottle while walking, or for those who have the use of only one hand.

### BRIEF DESCRIPTION OF THE SEVERAL VIEWS OF THE DRAWING

The nature and advantages of the present invention will be understood more clearly from the following descriptions made with reference to the accompanying drawings, in which:

FIG. 1 is a perspective view of an exemplary bottle opener being held in the hand in its operative position upon a bottle cap. The hatched arrows show the direction of force upon the opener by the hand and the subsequent direction of motion of as the cap is removed.

FIG. 2 is a perspective view of the exemplary bottle opener shown in FIG. 1, with the bottle and hand removed.

### DETAILED DESCRIPTION OF THE INVENTION

Identical reference numbers in the drawings and referred to below identify similar or corresponding elements.

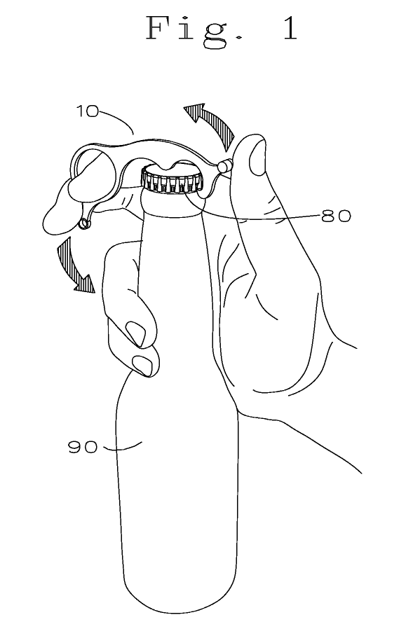

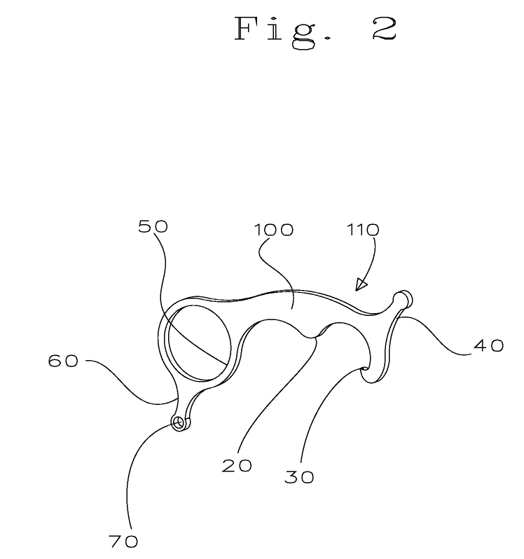

Referring to FIGS. 1-2, one embodiment of bottle opener 10 generally comprises a substantially rigid panel having a first side surface 100, a second side surface 110, a fulcrum surface 20, a nib 30, a thumb surface 40, an index finger surface 50, and a middle finger surface 60 wherein first side surface 100 and second side surface 110 are opposite surfaces, nib 30 and fulcrum surface 20 are disposed relative to each other to facilitate engagement with bottle cap 80 such that thumb surface 40, index surface 50 and middle finger surface 60 are reachable with the respective fingers while the bottle 90 is simultaneously held by the ring and little fingers against the palm of the hand. Surfaces 40, and 50 are disposed relative to each other to facilitate manipulation of opener 10 by thumb and index finger and, when opener 10 is in its operative position upon cap 80, pressure can be applied toward the palm of the hand by index and middle fingers upon surfaces 50 and 60 respectively and away from the palm and upward by the thumb upon surface 40, these forces acting in generally opposite directions forming a lever whose fulcrum is the contact point between the top of bottle cap 80 and surface 20, thus enabling a prying force between the fulcrum and lower edge of bottle cap 80 sufficient to remove cap 80 from bottle 90. Thumb pressure upon surface 40 also serves to force nib 30 under cap 80 and prevent nib 30 from slipping away from the cap flange. Each part of bottle opener 10 may be given such a direction and shape that fulcrum surface 20 rests on any desired part of the top portion of bottle cap 80, though preferably the fulcrum lies near the center of cap 80. The width of the bottle opener 10, which is the distance between first side surface 100 and second side surface 110 can be constant or varying. It is preferable that the width at nib 30 is sufficient to enable engagement of at least a semi circumference of the bottle cap edge. Elsewhere this width is sufficient to enable physical comfort in the hand of the user while providing enough strength to withstand the forces of decapping the bottle. An eyelet 70 may be disposed at a location on opener 10 as a means to attach a lanyard or other device. Index finger surface 50 may form a closed or nearly closed ring to facilitate retention of bottle opener 10 upon the index finger or other finger while the opener is not in use. In another embodiment of the invention, middle finger surface 60 may be omitted, the resulting opener being operable using a finger and thumb only.

1-5. (canceled)

6. A bottle opener for uncapping a bottle that has been sealed with a crown cap comprising:
a nib adapted to engage a portion of a bottle cap edge;
a thumb surface positioned proximate and opposite to said nib;
a fulcrum surface positioned relative to said nib to engage a portion of a top surface of a bottle cap when said nib engages said portion of a bottle cap edge;
an index finger surface positioned on the opposite side of said fulcrum surface from said nib and said thumb surface and oriented approximately opposite said thumb surface;
said thumb surface and said index finger surface oriented such that applying a force into each of said surfaces results in a rotary force on said nib about said fulcrum surface.

7. The bottle opener of claim 6 further comprising a middle finger surface proximate said index finger surface and positioned in approximately the same orientation as said index finger surface.

8. The bottle opener of claim 6 adapted to allow a user to use a single hand to both hold a bottle and manipulate said opener to remove a cap on said bottle.

9. The bottle opener of claim 7 adapted to allow a user to use a single hand to both hold a bottle and manipulate said opener to remove a cap on said bottle.

10. The bottle opener of claim 6 wherein the index finger surface comprises a portion of an interior surface of a ring adapted to receive an index finger of a user.

11. The bottle opener of claim 7 wherein the index finger surface comprises a portion of an interior surface of a ring adapted to receive an index finger of a user.

12. The bottle opener of claim 10 adapted to allow a user to use a single hand to both hold a bottle and manipulate said opener to remove a cap on said bottle.

13. The bottle opener of claim 11 adapted to allow a user to use a single hand to both hold a bottle and manipulate said opener to remove a cap on said bottle.
